(19) United States
(12) Patent Application Publication
(10) Pub. No.: US 2026/0167212 A1
(43) Pub. Date: Jun. 18, 2026

(54) Method and System for Increasing a Driver’s Confidence in an Automated Driving Function

(71) Applicant: Bayerische Motoren Werke Aktiengesellschaft, Muenchen (DE)

(72) Inventors: Yannick FORSTER, Muenchen (DE); Frederik NAUJOKS, Muenchen (DE)

(21) Appl. No.: 19/124,946

(22) PCT Filed: Nov. 8, 2023
(86) PCT No.: PCT/EP2023/081126

§ 371 Date: Apr. 28, 2025

(30) Foreign Application Priority Data
Nov. 11, 2022 (DE) 10 2022 129 911.2

(51) Int. Cl. B60W 50/14; B60W 40/09; B60W 60/00

(52) U.S. Cl. CPC B60W 50/14; B60W 40/09; B60W 60/001; B60W 2540/225; B60W 2540/229

(57) ABSTRACT

A method for increasing a driver's confidence in an automated driving function of a vehicle includes receiving gaze behavior information about a detected gaze behavior of the driver. The gaze behavior information is evaluated with respect to an intensity with which the driver monitors the automated driving function. A command to output confidence-building information to the driver is generated depending on the intensity with which the driver monitors the automated driving function.

### BACKGROUND AND SUMMARY

The disclosure relates to a method and a system for increasing a driver's trust in an automated driving function of a vehicle. The disclosure further relates to a data processing device, a computer-readable storage medium and a computer program for carrying out such a method.

Most modern motor vehicles are equipped with driving assistance systems which provide automated driving functions. The automated driving functions can automatically carry out the automated driving functions, for example longitudinal and/or lateral guidance of a vehicle at least temporarily or in particular situations. Examples of automated driving functions that are becoming more widespread are automatic adaptive cruise control (ACC), a steering and lane guidance assistant, and a parking assistant.

It is crucial for the acceptance of automated driving functions that vehicle users have sufficient trust in the automation (known as automation trust). The challenge arising here for vehicle manufacturers is that of ensuring that, on the one hand, the automation trust reaches a specific minimum in order that the automated driving functions are even utilized, but, on the other hand, it does not exceed a certain level either so that overtrust in the automation is prevented, which may result in overreliance on a system, leading to safety-critical behavior of the driver. For example, overtrust in a level 2 system could manifest itself as impermissible behavior such as the driver performing distracting secondary activities. In the case of a level 3 system, overtrust could even impermissibly give cause for a driver to sleep during the journey.

It is known from research that takeover requests made to the driver, which require the driver to intervene, can break the automation trust of the driver in an automated driving function (see, for example, Hergeth, S., Lorenz, L., Vilimek, R., & Krems, J. F. (2016). Keep your scanners peeled: Gaze behavior as a measure of automation trust during highly automated driving. Human factors, 58(3), 509-519.). After such a break in trust, the automation trust builds back up only slowly in some circumstances.

Based on this, it is an object of the embodiments described herein to specify a method and a system for increasing a driver's trust in an automated driving function, in particular after the trust in the automated driving function has been broken.

The object is achieved by the features and embodiments described herein.

It is pointed out that additional features of a patent claim dependent on an independent patent claim, without the features of the independent patent claim or only in combination with a subset of the features of the independent patent claim, can form a separate invention which is independent of the combination of all features of the independent patent claim and can be made into the subject matter of an independent claim, a divisional application or a subsequent application. This applies in the same manner to technical teachings which are described in the description and can form an invention independent of the features of the independent patent claims.

At least one embodiment relates to a method for increasing a driver's trust in an automated driving function of a vehicle.

The vehicle may be a motor vehicle, in particular a road-based motor vehicle.

The automated driving function enables automated driving of the vehicle. Within the scope of the present document, the term “automated driving” is understood as meaning driving with automated longitudinal and/or lateral guidance. Automated driving may involve, for example, driving on the freeway for a relatively long time or driving for a limited time during parking.

The term “automated driving”, as used in this document, comprises automated driving with any degree of automation. Exemplary degrees of automation are assisted, semiautomated, partially automated, highly automated and fully automated driving (each with an increasing degree of automation). The five degrees of automation mentioned above correspond to SAE levels 1 to 5 of the SAE J3016 standard (SAE-Society of Automotive Engineering) as of Apr. 30, 2021. In the case of assisted driving (SAE level 1), the system performs the longitudinal or lateral guidance in certain driving situations. In the case of semiautomated driving (SAE level 2), the system undertakes the longitudinal and lateral guidance in certain driving situations, but the driver must permanently monitor the system as in the case of assisted driving. In the case of partially automated driving (SAE level 3), the system undertakes the longitudinal and lateral guidance in certain driving situations without the driver having to permanently monitor the system; however, the driver must be able to take over the vehicle guidance within a certain time upon request by the system. In the case of highly automated driving (SAE level 4), the system undertakes the vehicle guidance in certain driving situations, even if the driver does not react to a request to intervene, with the result that the driver is dispensed with as a fallback level. In the case of fully autonomous driving (SAE level 5), the system can perform all aspects of the dynamic driving task which are also handled by a human driver under any road and environmental condition.

The method according to at least one embodiment comprises the following steps which can be carried out by means of a data processing device:

In one method step, gaze behavior information about a detected gaze behavior of the driver is received.

For example, such gaze behavior information can be detected by means of a driver camera or an interior camera of the vehicle and then be provided to the data processing device.

In another step, the gaze behavior information is evaluated with respect to an intensity with which the driver is monitoring the automated driving function.

For example, the gaze behavior can be used to determine how significantly, that is to say, for example, how frequently, the driver is monitoring the correct operation of the automated driving function by the driver looking at corresponding status indicators in relation to the automated driving function, for example, which are displayed on an instrument cluster, a display screen or another display device.

The gaze behavior can be used to ascertain a reliance behavior or a parameter characterizing the degree of automation trust of the driver. For example, a lower trust level can be inferred here, the more frequently the driver changes between a non-driving activity (for example reading a book or the like) and the driver viewing displayed status indicators of the automated driving function and/or looking outward through a windowpane (in particular a windshield) at the vehicle surroundings. In particular, it is possible to determine here whether and how significantly the reliance behavior of the driver or a parameter characterizing the degree of automation trust of the driver has reduced in a situation.

In yet another step of the method, an instruction to output trust-building information to the driver is generated, wherein the instruction is generated depending on the intensity with which the driver is monitoring the automated driving function.

The trust-building information may be, for example, a transparency message and/or an apology and/or an emotional-motivational message, as is explained further below in more detail.

The trust-building information may be output in acoustic and/or visual fashion, for example, by means of an output device. In other words, the instruction generated may be output at an output device in the form of a speech output device and/or a visual display and be further processed there accordingly. For example, a speech output may be provided as the primary medium for communicating the trust-building information, where a visual display may additionally be used to present information to the driver in an understandable way or to visually illustrate particular connections.

According to one embodiment, the evaluation of the gaze behavior information comprises ascertaining a monitoring frequency (see, for example, Hergeth, S., Lorenz, L., Vilimek, R., & Krems, J. F. (2016). Keep your scanners peeled: Gaze behavior as a measure of automation trust during highly automated driving. Human factors, 58(3), 509-519.) indicating how frequently the driver is monitoring the automated driving function. The instruction to output the trust-building information is generated in this case depending on the monitoring frequency.

For example, ascertaining the monitoring frequency may comprise ascertaining a frequency with which the driver checks the correct functioning of the automated driving function in a particular time interval, which may have a duration in the range of 30 seconds to 1 minute, for example. The time interval here may be a continuous time interval, that is to say a respective current ascertained frequency can be determined in relation to the last 30 seconds, the last minute or the like, as a result of the monitoring frequency.

As an alternative or in addition to ascertaining a monitoring frequency, other circumstances can also be taken into account in the evaluation of the gaze behavior, or more generally in the determination of the reliance behavior or a parameter characterizing the degree of automation trust of the driver, such as whether the driver is looking at a mobile device (for example a smartphone) or an electronic entertainment device or is using one. In the latter case, this can be considered an indication of a relatively high automation trust since the driver is directing their attention to things other than the automated driving function.

According to one embodiment, the trust-building information includes a transparency message explaining to the driver a behavior exhibited by the automated driving function. The behavior exhibited by the automated driving function may include, for example, an action performed by the automated driving function or else a non-action of the driving function in a particular situation. The non-action of the driving function may be, for example, the failure of the automated driving function to intervene in the vehicle guidance, which would have been expected by the driver according to the driving situation or which would have corresponded to conventional, situation-appropriate vehicle guidance in the case of a manually guided vehicle. The transparency message may then be used to retrospectively explain to the driver the behavior exhibited and to make it understandable or plausible for them. This can re-consolidate the trust of the driver in the automated driving function after it has been temporarily reduced by the behavior of the automated driving function.

As an alternative or in addition to a transparency message, the trust-building information may include an apology and/or an emotional-motivational message in relation to a behavior exhibited by the automated driving function. This can initiate trust repair on a motivational and emotional level, for example by the system apologizing (for example using the words: “I am sorry that I gave you control with only a short warning”) and optionally additionally issues an emotional-motivational explanation (for example: “I know that this requires stress and a fast reaction but you did this very well and reacted. Thank you for supporting my system limit.”). This can advantageously accelerate repair of the automation trust of the driver.

The method may further comprise receiving behavior information about a behavior exhibited by the automated driving function. The instruction to output the trust-building information is generated here depending on the behavior information.

Provision may be made, for example, for the instruction to output the trust-building information to be generated at all only if the automated driving function has exhibited a particular (predefined) behavior. According to some embodiment variants, provision may be made for even the step of evaluating the gaze behavior information to be carried out only if the behavior information reveals that the automated driving function has exhibited a particular behavior.

For example, the behavior information can be provided by a control module, which controls the automated driving function.

With respect to the embodiments described herein, which are based on a behavior exhibited by the automated driving function, provision may be made for the behavior to include an element or multiple elements from the following list: an action executed by the automated driving function; the omission of an action by the automated driving function (for example an action that the automatic driving function ought to have carried out in accordance with regulations or in accordance with the driver's expectation in a particular situation); a downgrading (that is to say a controlled reduction of the scope of a function) or deactivation of the automated driving function; an error notification output to the driver in relation to the automated driving function (such as a suggestion to downgrade or a suggestion of system limits of the automated driving function); a takeover request directed at the driver; a behavior (such as a downgrading or deactivation of the automated driving function or a takeover request) requiring the driver to intervene in a vehicle guidance process otherwise executed by the automated driving function (instead of or in addition to vehicle guidance carried out by the automated driving function); a malfunction of the automated driving function.

According to at least one embodiment, based on received behavior information, a first intensity with which the driver is monitoring (has monitored) the automated driving function at a time (in particular a short time) after the behavior exhibited by the automated driving function (for example at approximately the present time) is compared with a second intensity with which the driver has monitored the automated driving function at a time before (for example shortly before) the behavior exhibited by the automated driving function. The instruction to output the trust-building information is then generated depending on a result of the comparison of the first intensity with the second intensity.

As an alternative or in addition to the comparison of the first intensity with the second intensity, according to at least one embodiment, provision may be made for a third intensity with which the driver has monitored the automated driving function a short time after the behavior exhibited by the automated driving function is compared with a fourth intensity with which the driver is monitoring (has monitored) the automated driving function a longer time after the behavior exhibited by the automated driving function (for example approximately at the present time). The instruction to output the trust-building information is generated in this case depending on a result of the comparison of the third intensity with the fourth intensity. In at least one embodiment, which provides both the above-described comparison of the first intensity with the second intensity and the comparison of the third intensity with the fourth intensity, the third intensity may be identical to the first intensity explained further above.

In at least one embodiment, a data processing device is configured to carry out a method according to the aspects and embodiments described herein. The data processing device may, for example, be in the form of an electronic controller comprising one or more programmable processors.

In at least one embodiment, a system for increasing a driver's trust in an automated driving function of a vehicle is provided. The system comprises a detection device for detecting a gaze behavior of the driver. For example, the detection device may comprise a driver camera or an interior camera of the vehicle.

The system furthermore comprises a data processing device configured to receive gaze behavior information about the detected gaze behavior; evaluate the gaze behavior information with respect to an intensity with which the driver is monitoring the automated driving function; and generate an instruction to output trust-building information to the driver depending on the intensity with which the driver is monitoring the automated driving function.

The data processing device of the system may be a data processing device according to the second aspect of the invention, that is to say a data processing device configured to carry out the method(s) described herein.

The system further comprises an output device for outputting the trust-building information depending on the instruction generated by means of the data processing device. The information may be output, for example, in acoustic and/or visual fashion. The output device may accordingly comprise, for example, an acoustic speech output device and/or a visual display.

In at least one embodiment, a computer program includes instructions which, when the computer program is executed by a data processing device (such as the data processing device described herein), cause the latter to carry out the method(s) described herein. It is thus possible to use a computer program when carrying out the method(s) described herein.

In at least one embodiment, a non-transitory computer-readable storage medium stores the computer program.

The features of the method(s) described herein can also be correspondingly implemented in the data processing device, the system, the computer program, and the storage medium, and vice versa.

In accordance with some embodiments described above and below, the systems and methods described herein advantageously makes it possible to re-establish automation trust of a driver in accelerated fashion after the automation trust has initially been reduced due to a behavior exhibited by the automated driving function. This may relate, for example, to a situation in which the driver had to intervene in the lateral and/or longitudinal guidance otherwise carried out by the automated vehicle guidance system.

The accelerated re-establishment of the automation trust is achieved by virtue of trust-building information being output to the driver, for example in a form whereby a system function apologizes to the driver for the action that led to the loss of trust.

So as not to unnecessarily distract the driver, however, the trust-building information is output depending on whether a break of trust has actually been determined after the action. This is done by way of a trust behavior measurement, in which a degree of automation trust is ascertained by monitoring the gaze behavior of the driver.

For example, detected gaze behavior parameters may be used to determine a monitoring frequency indicating how frequently (for example in each case at a predetermined continuous time interval) the driver checks the automated driving function. If, for example after a takeover request or another system communication of the automated driving function, a significant decline in such a trust parameter is determined, such as the monitoring frequency, trust-building information is output depending on the determined break of trust. In this case, in addition to a transparency message addressing the driver on an analytical level and explaining to them the behavior of the automated driving function, trust repair can be initiated on a motivational and emotional level by virtue of the system apologizing and, in some circumstances, also issuing an emotional-motivational explanation.

In one exemplary scenario, a reduction in trust behavior of the driver has been measured shortly after the automated driving function (including the takeover request to the driver) is downgraded taking into account the gaze behavior of the driver. After the automated driving function was subsequently reactivated and has functioned without fault for a certain amount of time, the trust behavior can be remeasured. Trust-building information can then be output depending on a difference between the trust parameters determined at the respective points in time (according, for example, to a difference between the aforementioned fourth intensity and third intensity).

For example, provision may be made here for no trust-building information at all or only a transparency message to be output if it is determined that the automation trust has already entirely or substantially improved or that it was not broken at all in the first place after the downgrading. For example, in the event of a level 3 driving function, the output of a transparency message (or no trust-building information at all) may suffice if it is determined that the driver has returned to playing on a smart phone or the like and has accordingly not or has hardly monitored the automated driving function.

In contrast, if it is determined that the automation trust is still moving to a low level, for example based on the observation that the driver is frequently monitoring the correct functioning of a level 3 driving function, an apology and/or an emotional-motivational message can be output in addition to a transparency message.

The various embodiments and aspects thereof will now be explained in more detail with reference to the accompanying drawings. The features and combinations of features mentioned in the description and/or shown in the drawings alone can be used not only in the respectively stated combination, but also in other combinations or alone, without departing from the scope of the invention.

### BRIEF DESCRIPTION OF THE DRAWINGS

FIG. 1 schematically shows an example of a system for increasing a driver's trust in an automated driving function.

FIG. 2 shows a schematic flowchart of a method for increasing a driver's trust in an automated driving function.

### DETAILED DESCRIPTION OF THE DRAWINGS

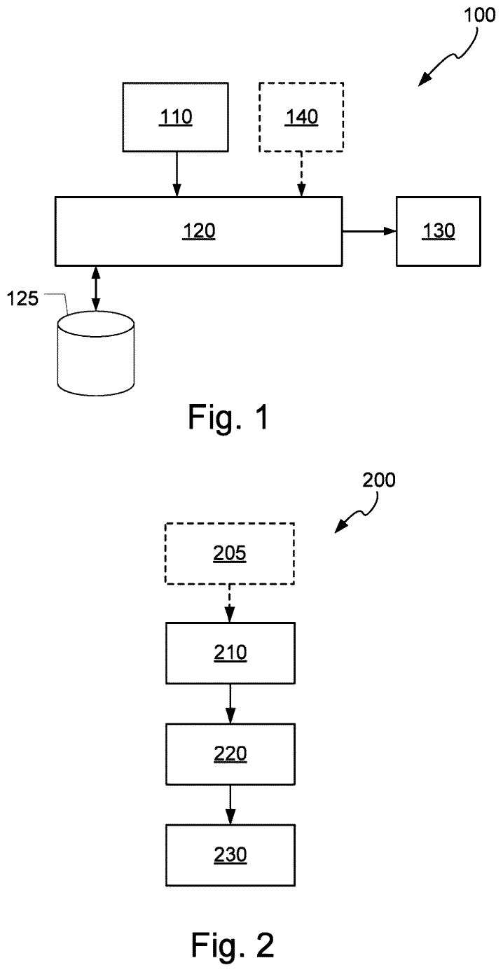

FIGS. 1-2 illustrate a system 100 and method 200 for increasing a driver's trust in an automated driving function of a vehicle.

The system 100 comprises a detection device 110 and is configured to detect a gaze behavior of the driver by means of the detection device 110. For example, the detection device 110 may comprise a driver camera (directed toward the driver) or an interior camera of the vehicle.

The detection device 110 is communicatively connected to a data processing device 120 of the system 100. The data processing device 120 is configured to receive information provided by the detection device 110 and to further process it logically.

In particular, the data processing device 120 is configured to: receive 210 gaze behavior information about the gaze behavior detected by means of the detection device 110; evaluate 220 gaze behavior with respect to an intensity with which the driver is monitoring the automated driving function; and generate 230 an instruction to output trust-building information to the driver depending on the intensity with which the driver is monitoring the automated driving function.

The aforementioned steps 210, 220, 230 correspond to steps of the method 200 from FIG. 2, which are explained in more detail further below. The data processing device 120 is consequently configured to carry out the method 200.

In the exemplary embodiment illustrated in FIG. 1, the data processing device 120 is connected to a computer-readable storage medium 125, which contains a computer program. When the computer program is executed by the data processing device 120, the latter is caused to carry out the aforementioned steps 210-230.

The system 100 further comprises an output device 130 for outputting the trust-building information depending on the instruction generated by means of the data processing device 120. The information may be output, for example, in acoustic and/or visual fashion. The output device 130 may accordingly comprise, for example, an acoustic speech output device and/or a visual display.

In addition to the information about the detected gaze behavior, the data processing device 120 can receive additional information and take this into account when generating 230 the instruction to output trust-building information.

For example, the data processing device 120 according to FIG. 1 may optionally also be connected to a control module 140, which controls the automated driving function. The data processing device 120 may receive from the control module 140, for example, behavior information about a behavior exhibited by the automated driving function.

FIG. 2 schematically shows steps 205, 210, 220, 230 of a computer-implemented method 200 for increasing a driver's trust in an automated driving function. The method may be carried out by means of the data processing device 120 of the system 100 from FIG. 1.

The method 200 from FIG. 2 is explained in the following text with reference to the system 100 from FIG. 1.

In one step 210 of the method 200, gaze behavior information about a detected gaze behavior of the driver is received by the data processing device 120. For example, the gaze behavior may have been detected by means of the detection device 110 from FIG. 1 and corresponding gaze behavior information can be provided to the data processing device 120 from FIG. 1.

In another step 220, the gaze behavior information is evaluated with respect to an intensity with which the driver is monitoring the correct functioning of the automated driving function.

For example, the evaluation 220 of the gaze behavior information may comprise ascertaining a monitoring frequency. The monitoring frequency indicates how frequently (in particular per unit of time, for example in each case in relation to a continuous time interval with a duration in the range of from 30 to 60 seconds) the driver is monitoring the automated driving function.

Another step of the method 200 is the generation 230 of an instruction to output trust-building information to the driver depending on the intensity with which the driver is monitoring the automated driving function. The data processing device 120 may thus generate the instruction depending on a result of the evaluation 220 and transmit the instruction, for example for further processing, that is to say, in particular, for the actual information output, to the output device 130 from FIG. 1.

The trust-building information may include, for example, a transparency message explaining to the driver a behavior exhibited by the automated driving function. As an alternative or in addition thereto, the trust-building information may include an apology directed toward the driver and/or an emotional-motivational message (both in relation to a behavior exhibited by the automated driving function).

In an optional further method step 205, which may precede the method steps 210-230 explained above, for example, the data processing device 120 receives behavior information about a behavior exhibited by the automated driving function. For example, the behavior information can be provided by the control module 140 from FIG. 1.

The behavior exhibited by the automated driving function may include, for example, an element or multiple elements from the following list: an action executed by the automated driving function; the omission of an action by the automated driving function (for example an action that the automatic driving function ought to have carried out in accordance with regulations or in accordance with the driver's expectation in a particular situation); a downgrading (that is to say a controlled reduction of the scope of a function) or deactivation of the automated driving function; an error notification output to the driver in relation to the automated driving function (such as a suggestion to downgrade or a suggestion of system limits of the automated driving function); a takeover request directed at the driver; a behavior (such as a downgrading or deactivation of the automated driving function or a takeover request) requiring the driver to intervene in a vehicle guidance process otherwise executed by the automated driving function (instead of or in addition to vehicle guidance carried out by the automated driving function); a malfunction of the automated driving function.

The instruction to output the trust-building information may then be generated 230 depending on the behavior information. Provision may be made, for example, for the instruction to output the trust-building information to be generated at all only when the automated driving function has exhibited a particular (predefined) behavior. According to some embodiment variants, provision may be made for even the step of evaluating the gaze behavior information to be carried out only when the behavior information reveals that the automated driving function has exhibited a particular (predefined) behavior.

For example, in the process of evaluating 220 the gaze behavior, a first intensity with which the driver is monitoring (has monitored) the automated driving function at a time (in particular a short time) after a particular behavior exhibited by the automated driving function (for example at approximately the present time) is compared with a second intensity with which the driver has monitored the automated driving function at a time before (for example shortly before) the behavior exhibited by the automated driving function. The instruction to output the trust-building information is then generated 230 depending on a result of the comparison of the first intensity with the second intensity.

As an alternative or in addition to the comparison of the first intensity with the second intensity, in the process of the evaluation 220, provision may be made for a third intensity with which the driver has monitored the automated driving function a short time after the behavior exhibited by the automated driving function is compared with a fourth intensity with which the driver is monitoring (has monitored) the automated driving function a longer time after the behavior exhibited by the automated driving function (for example approximately at the present time). The instruction to output the trust-building information is generated in this case depending on a result of the comparison of the third intensity with the fourth intensity. In one embodiment variant which provides both the above-described comparison of the first intensity with the second intensity and the comparison of the third intensity with the fourth intensity, the third intensity may be identical to the first intensity explained further above.

As a result, the proposed system 100 and the proposed method 200 can advantageously be used for accelerated reestablishment of automation trust after it has been reduced as a result of a behavior of the automated driving function.

1-11. (canceled)

12. A computer-implemented method for increasing a driver's trust in an automated driving function of a vehicle, the method comprising:
receiving gaze behavior information about a detected gaze behavior of the driver;
evaluating the gaze behavior information with respect to an intensity with which the driver is monitoring the automated driving function; and
generating an instruction to output trust-building information to the driver depending on the intensity with which the driver is monitoring the automated driving function.

13. The method of claim 12, wherein the evaluation of the gaze behavior information includes ascertaining a monitoring frequency indicating how frequently the driver checks the automated driving function, and wherein the instruction to output the trust-building information is generated depending on the monitoring frequency.

14. The method of claim 12, wherein the trust-building information includes at least one of:
a transparency message explaining to the driver a behavior exhibited by the automated driving function;
an apology in relation to a behavior exhibited by the automated driving function; and
an emotional-motivational message in relation to a behavior exhibited by the automated driving function.

15. The method of claim 12, further comprising:
receiving behavior information about a behavior exhibited by the automated driving function, wherein the instruction to output the trust-building information is generated depending on the behavior information.

16. The method of claim 15, wherein the behavior exhibited by the automated driving function includes one or more of:
an action executed by the automated driving function,
the omission of an action by the automated driving function,
a downgrading or deactivation of the automated driving function,
an error notification output to the driver in relation to the automated driving function;
a takeover request directed at the driver,
a behavior requiring the driver to intervene in a vehicle guidance process otherwise executed by the automated driving function, and
a malfunction of the automated driving function.

17. The method of claim 15, wherein a first intensity with which the driver has monitored the automated driving function at a time after the behavior exhibited by the automated driving function is compared with a second intensity with which the driver has monitored the automated driving function at a time before the behavior exhibited by the automated driving function, and wherein the instruction to output the trust-building information is generated depending on a result of the comparison of the first intensity with the second intensity.

18. The method of claim 17, wherein a third intensity with which the driver has monitored the automated driving function a short time after the behavior exhibited by the automated driving function is compared with a fourth intensity with which the driver has monitored the automated driving function a longer time after the behavior exhibited by the automated driving function, and wherein the instruction to output the trust-building information is generated depending on a result of the comparison of the third intensity with the fourth intensity.

19. A non-transitory computer readable medium storing instructions executable by a computing device to carry out the method of claim 12.

20. A system for increasing a driver's trust in an automated driving function of a vehicle, comprising:
a detection device for detecting a gaze behavior of the driver;
a data processing device configured to:
receive gaze behavior information about the detected gaze behavior,
evaluate the gaze behavior information with respect to an intensity with which the driver is monitoring the automated driving function, and
generate an instruction to output trust-building information to the driver depending on the intensity with which the driver is monitoring the automated driving function; and
an output device for outputting the trust-building information depending on the instruction.
